(19) United States
(12) Patent Application Publication
(10) Pub. No.: US 2016/0133148 A1
(43) Pub. Date: May 12, 2016

(54) INTELLIGENT CONTENT ANALYSIS AND CREATION

(71) Applicant: PrepFlash LLC, Austin, TX (US)

(72) Inventors: John Phillip Hanks, Austin, TX (US); Peter Huan Yu, College Station, TX (US); Vincent Chun-Wen Chen, College Station, TX (US); Ying-Po Liao, Taipei (TW)

(21) Appl. No.: 14/926,991

(22) Filed: Oct. 29, 2015

Related U.S. Application Data
(60) Provisional application No. 62/076,171, filed on Nov. 6, 2014.

(51) Int. Cl. G09B 7/06

(52) U.S. Cl. CPC G09B 7/06

(57) ABSTRACT

A computer system for intelligently parsing digital content and generating questions based upon the digital content can be configured to receive a digitally encoded file. The system can extract text content from the digitally encoded file. The system can then process the text content through an intelligent text analysis process. The intelligent text analysis process can identify key phrases within the digital content. The system can generate a question based upon a particular key phrase by manipulating a portion of the extracted text content. Further, the system can display, on a display device, the generated question.

### CROSS-REFERENCE TO RELATED APPLICATIONS

This application claims priority to and the benefit of U.S. Provisional Application Ser. No. 62/076,171, entitled “Method for Creating Interactive Study Aids from Images and Text”, filed on Nov. 6, 2014, the entire contents of which is incorporated herein by reference in its entirety.

### BACKGROUND OF THE INVENTION

1. Technical Field

This invention relates to the field of intelligent content analysis.

2. Background and Relevant Art

Conventional study and learning aids such as flashcards, true/false quizzes, and multiple choice exams are typically developed by a student or teacher from various class materials. For example, a student may review their handwritten class notes and create flashcards based upon key points that were discussed. The process of creating study aids and reviewing study aids can be a daunting and time consuming task for content rich classes.

In more recent years, software-based study aids have been presented as an alternative to handwritten study aids. Conventional software aids are created by typing keywords and definitions into a software program. The software can then create computer-generated flashcards using the manually-entered definitions and keywords. In some conventional software-based systems, multiple choice questions can be created by the teacher or student manually providing incorrect alternatives to the answer. These incorrect answers can be used as decoy answers. In any case, long and tedious work is required to utilize conventional software-based study aids. As such, there are several problems to address within the field of intelligent content analysis for software-based study aids.

### BRIEF SUMMARY OF THE INVENTION

Implementations of the present invention comprise systems, methods, and apparatus configured to intelligently analyze digital content and generate study-aid questions based upon the analyzed content. In particular, implementations of the present invention comprise systems and methods for receiving class notes, class slides, class audio recordings, class video recording, and any other known digital media. The received content can then be automatically analyzed using natural language processing to identify potential questions and answers that can be presented to a user. As such, novel users of artificial intelligence can assist a user in creating study aids based upon user provided content.

Implementations of the present invention include computer systems for intelligently parsing digital content and generating questions based upon the digital content. The system can be configured to receive a digitally encoded file, wherein the digitally encoded file comprises a known information media type. The system can extract text content from the digitally encoded file. The system can then process the text content through an intelligent text analysis process. The intelligent text analysis process can identify key phrases within the digital content. The system can generate a question based upon a particular key phrase by manipulating a portion of the extracted text content. Further, the system can display, on a display device, the generated question.

Implementations of the present invention also include a method for intelligently parsing digital content and generating questions based upon the digital content. The method can comprise receiving a digitally encoded file, wherein the digitally encoded file comprises a known information media type. The method can also comprise extracting text content from the digitally encoded file. Additionally, the method can comprise processing the text content through an intelligent text analysis process. The intelligent text analysis process can identify key phrases within the digital content. The method can also comprise generating a question based upon a particular key phrase. Further, the method can comprise displaying, on a display device, the generated question.

Yet another implementation of the present invention can include another computer system for intelligently parsing digital content and generating questions based upon the digital content. The computer system can be configured to receive a digitally encoded file. Additionally, the system can extract text content from the digitally encoded file. The system can also process the text content through an intelligent text analysis process. The intelligent text analysis process can identify key phrases within the digital content. The system can then generate a set of decoy answers by processing a particular key phrase through a decoy generator. Further, the system can generate a question based upon the particular key phrase by manipulating a portion of the extracted text content. Further still, the system can display, on a display device, the generated question and the set of decoy answers.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of an implementation of a computer system for intelligently parsing digital content and generating questions based upon the digital content;

FIG. 2 illustrates example questions and answers that can be generated by the computer system of FIG. 1;

FIG. 3 illustrates a flowchart of steps within an implementation of a method for intelligently parsing digital content and generating questions based upon the digital content;

FIG. 4 illustrates a flowchart of steps within an implementation of a method for intelligently generating decoy answers;

FIG. 5 illustrates implementation of data objects used to identify decoy answers; and

FIG. 6 illustrates a flow chart of a series of acts in a method for intelligently generating questions.

### DETAILED DESCRIPTION OF THE PREFERRED EMBODIMENTS

The present invention extends to systems, methods, and apparatus configured to intelligently analyze digital content and generate study-aid questions based upon the analyzed content. In particular, implementations of the present invention comprise systems and methods for receiving class notes, class slides, class audio recordings, class video recording, and any other known digital media. The received content can then be automatically analyzed using natural language processing to identify potential questions and answers that can be presented to a user. As such, novel users of artificial intelligence can assist a user in creating study aids based upon user provided content.

Accordingly, implementations of the present invention provide significant benefits in the automated generation of study-aids. In particular, questions can be automatically and intelligently generated from a wide array of different materials. For example, a student enrolled in an online class can automatically generate review questions directly from a video stream. Similarly, a student can scan their notes and automatically generate questions based upon their handwritten notes. In at least one implementation, multiple different media-types can be used to generate a single question set. For example, a student may generate a set of questions based upon input from both a video recording of a class lecture, assigned webpage readings, and class notes from reading.

Implementations of the present invention can also generate convincing, human-like decoy answers for multiple choice questions. For example, implementations of the present invention can identify a particular key phrase to base a question on, identify potential decoy phrases, and rank the potential decoy phrases such that a set of convincing decoys can be presented to a user.

Systems and method described herein can be easily and seamlessly integrated into both standard and online classroom environments. For example, questions can be generated based upon audio recordings of lectures, video recordings of lectures, scanned copies of handouts, scanned copies of handwritten notes, PDF files, web pages associated with a topic of interest, typed text files, or from any other information source. Additionally, questions can be automatically created by either teachers or students as needed. For instance, a student may be struggling with a particular portion of material. The student may decide to generate extra questions regarding the particular subject matter, in order to master the material.

Accordingly, implementations of the present invention provide many improvements in the field of study-aid generation. Additionally, implementations of the present invention provide significant, novel and non-obvious improvements to the technical field of computer intelligence that is required to generate good questions. Further, implementations of the present invention provide significant novel improvements to the scope of data sources that are available to automatically generate questions.

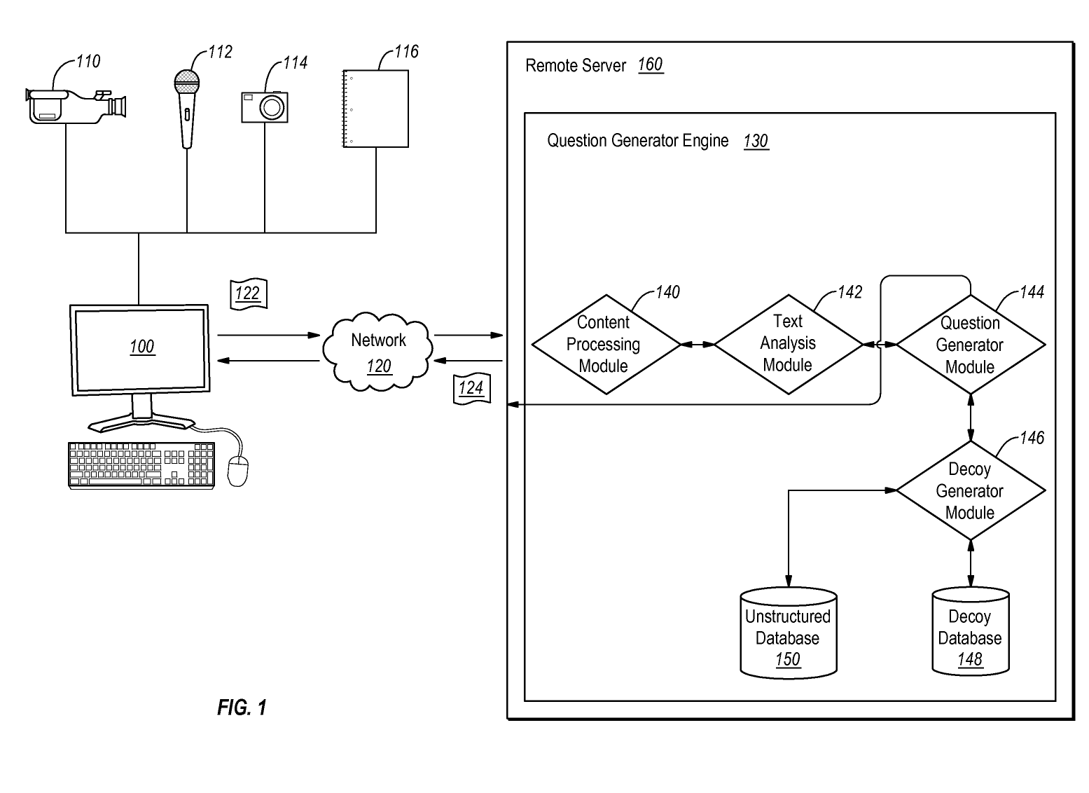

Turning now to the figures, FIG. 1 illustrates a schematic diagram of an implementation of a computer system for intelligently parsing digital content and generating questions based upon the digital content. In particular, FIG. 1 depicts various exemplary input sources 110, 112, 114, 116 that can provide content to a Question Generation Engine 130. For example, the depicted input sources include a video input 110, an audio input 112, an image input 114, and written input 116 (which has been scanned or otherwise imaged). In various additional implementations, a URL can be provided to the Question Generation Engine 130. The Question Generation Engine 130 can then access the URL, parse text provided at the URL, and generate questions based upon the parsed text. Additionally, in at least one implementation, text and be copy and pasted into the client computer 100, which can then send the text to the Question Generation Engine 130 for processing. As such, one will understand that the depicted and described input sources are meant to be merely exemplary, and that various implementations of the present invention can receive content in the form of any known digitally encoded format.

The various input devices may be in communication with a client computer 100. The client computer 100 may comprise a desktop computer, a laptop computer, a tablet computer, a smart phone, a wearable computing device, a standalone electronic device, such as a network connected audio recorder, or any other known recording and/or computing device. The client computer 100 may further be in communication with a Question Generation Engine 130. The Question Generation Engine 130 may comprise a software application. The software application may comprise various components that are executable on different computing systems, both local and remote.

The Question Generation Engine 130 may also be executed at a remote server 160 that the client computer 100 communicates with through a network connection 120. In such an implementation, the client computer 100 can transmit data packets 122 to the remote server 160. The transmitted data packets 122 may comprise content received from one or more input devices 110, 112, 114, 116. After processing, the remote server 160 can transmit data packets 124 back to the client computer 100. The transmitted data packets 124 may comprise questions generated by the Question Generation Engine 130.

As depicted, the Question Generation Engine 130 may comprise various modules and components for processing content and generating questions. For example, the Question Generation Engine 130 can comprise a content processing module 140, a text analysis module 142, a question generator module 144, a decoy generator module 146, a decoy database 148, and an unstructured database 150. One will understand, however, that the various modules and components of FIG. 1 are merely exemplary. Alternative implementations may comprise different modules, different configurations of modules, and/or different components for accomplishing the computerized methods and results described herein. Additionally, in alternative implementations, the various modules and components can be divided between the client computer 100, the remote server 160, and/or other local and remote computing devices. The modules and components of FIG. 1 are exemplary and are depicted for the sake of clarity and should not be read to limit the present invention to a particular form or configuration.

In at least one implementation, upon receiving a data packet 122 from the client computer 100, the content processing module 140 analyzes the content to determine the data type. For example, the content processing module 140 may determine that the received data comprises a video file, an audio file, or an image file. Based upon the identified the file type, the content processing module 140 can process the file to extract text content.

For instance, the content processing module 140 may utilize an optical character recognition (OCR) process to extract text from an image file (e.g., scanned image for notes, pdf of PowerPoints, image of book page, etc.). In contrast, when dealing with audio or video files, the content processing module 140 may utilize a voice-recognition process to automatically transcribe the audio recording into text. Further, in at least one implementation, when receiving a video file, or video stream, the content processing module 140 may extract closed captioned text from the video. As such, the content processing module 140 can extract text content from a variety of different data sources.

Once extracted, the text can be sent to the text analysis module 142 for further processing. The text analysis module 142 can analyze the received text and identify key phrases within various portions of the text. Additionally, the Text Analysis Module 142 can determine the key phrase types. For example, a key phrase may be a title, a name, a location, an event, or other similar things. As used herein, a key phrase includes single words or groups of words that provide subject-matter information within a sentence. In contrast, words such as prepositions, articles, and conjunctions, on their own do not provide subject-matter information. For example, in the sentence “Benjamin Franklin invented the bifocals,” the key phrases may comprise “Benjamin Franklin” and “bifocals.” In at least one implementation, the text analysis module 142 does not directly analyze the text and identify the key phrases. Instead, the text analysis module 142 can transmit the text to a third-party language analysis system, such as IBM's ALCHEMY API. The third-party language analysis system can then return various data about the text, such as key phrases.

Once the key phrases within the text are identified, both the text and the identified key phrases can be provided to the Question Generator Module 144. In at least one implementation, the Question Generator Module 144 can perform the function of creating an actual question and answer from the text. For example, the Question Generator Module 144 can determine a desired question type. In various implementations, the Question Generator Module 144 can generate true/false questions, fill-in the blank questions, multiple choice questions, and other various question types.

The Question Generator Module 144 can also identify a particular portion of the text (e.g., a particular sentence) and particular key phrase of interest within the particular portion of text. The Question Generator Module 144 can then create a question by manipulating the particular portion of text and/or the particular key phrase into a question. In at least one implementation, generated question-and-answer pairs can be loaded into an artificial intelligence component of the present invention for the purposes of training the artificial component. In at least one implementation, the artificial intelligence component may comprise IBM WATSON.

In the case that the Question Generator Module 144 is generating a multiple choice question, the Question Generator Module 144 can request decoy answers from the Decoy Generator Module 146. The Decoy Generator Module 146 may be in communication with a decoy database 148 and an unstructured database 150. The decoy database 148 may comprise a graph database that includes relational information about a large number of topics of interest. For example, the decoy database 148 may comprise information that allows the Decoy Generator Module 146 to provide suitable decoys for a particular key phrase.

In the case the decoy database 148 does not contain enough information to generate decoys, the Decoy Generator Module 146 can automatically curate decoys from the unstructured database 150. In various implementations, the unstructured database 150 can comprise the Internet. As such, in at least one implementation, structured data may be present within the unstructured database 150—the data is unstructured in as much as the entirety of the data is not uniformly structured within the decoy database 148.

Once the Question Generator Module 144 has the necessary information to generate a question, the Question Generator Module 144 can transmit a question back to the client computer 100 through data packets 124. The question may be transmitted to the client computer 100 through a web browser interface, through a standalone application, or through any other means. In at least one implementation, the Question Generator Module 144 can track the questions that the user gets correct and the questions that the user gets incorrect.

Additionally, the Question Generator Module 144 can also store key phrases and/or associated previously asked questions within a previous-question database. The Question Generator Module 144 can verify that newly generated questions and/or identified key phrases do not rely upon the same key phrase as the immediately previous questions. For example, the Question Generator Module 144 may be configured to only allow the same key phrase to be reused once every five questions. In other words, the Question Generator Module 144 may only allow the key phrase “George Washington” to be used only once every five questions.

Further, in at least one implementation, the Questions Generator Module 144 can create a vocabulary section that associates definitions with one or more key phrases. The definitions may be retrieved from a digital dictionary, an online resource (e.g., online dictionary), or from the user uploaded content. As such, in at least one implementation, in addition to providing a user with questions to test the user's knowledge, the Question Generator Module 144 can also provide a user with a vocabulary review.

In various implementations, triggers can be set that cause questions to be displayed at the client computer 100. For example, when a user pauses a video stream of a class lecture, a question and/or vocabulary definitions may be automatically displayed. The displayed question may cover content that was just covered in the video, or covered within a specific previous time period in the video. Similarly, a question can be displayed at the client computer 100 when the user pauses an audio recording. Accordingly, in at least one implementation, a user who is reviewing and learning from content can have questions generated in real-time based upon the content they are learning.

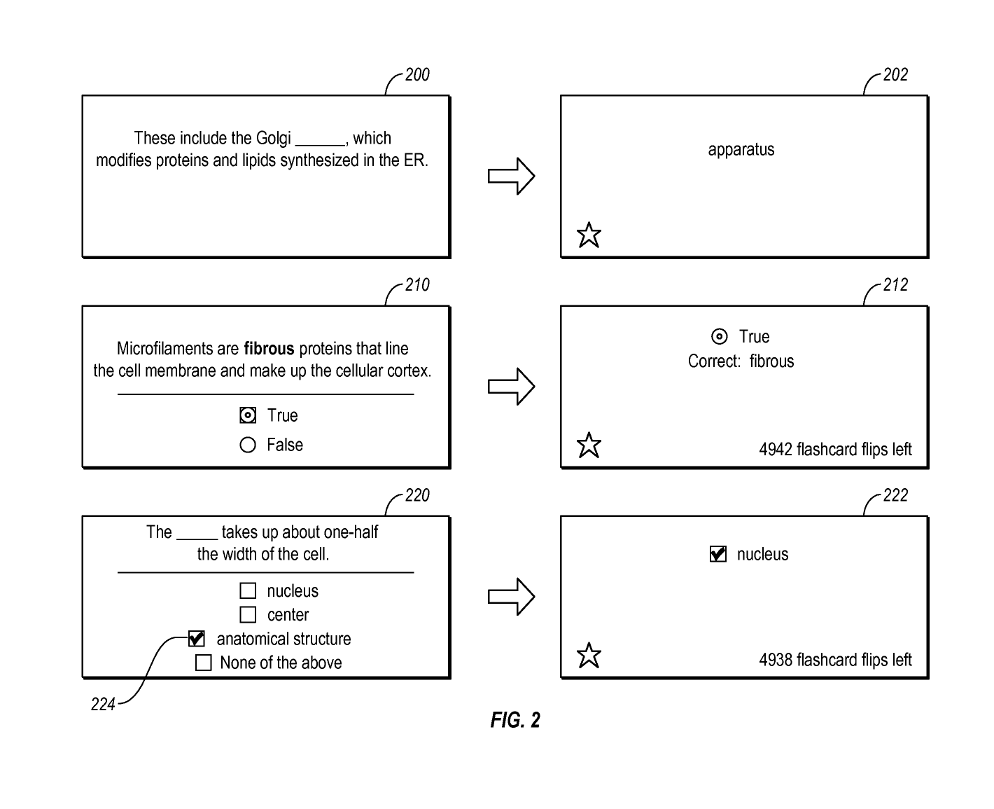

FIG. 2 illustrates example questions and answers that can be generated by the Question Generator Engine 130. Specifically, question 200 comprises a fill-in-the-blank question. A user can enter his answer using a keyboard at the client computer 100. Upon submitting his answer, an answer card 202 can be displayed to the user. The answer displayed by the answer card may comprise the key phrase that was extracted from the sentence by the Question Generator Module 144. Additionally, a star, or some other indicator, can be used to indicate a correct answer.

Question 210 depicts a true/false question. The question may comprise a bolded, or otherwise emphasized word, that is the focus of the true/false question. In particular, when generating the true/false question, the Question Generator Module 146 may identify a particular key phrase separated from the verb “is” and randomly insert a negative “not.” As such, the true/false question can comprise a portion of the originally processed text that has been manipulated with a negative. Similarly, a true/false question can be created by removing a negative, such as “not,” from a portion of the originally processed text. In contrast, in at least one implementation, the emphasized word may comprise a decoy word that has been inserted by the Question Generator Module 146. For example, the emphasized word “fibrous” may be a decoy for the correct key phrase “membrane.” As depicted by the answer card 212, however, the statement in question 210 was true.

Question 220 depicts a multiple choice question. The question may comprise a phrase from the original processed text with a key phrase missing. In addition to the question, various answers are presented to a user. The answers can be presented with accompanying selection indicators 224 (e.g., radio buttons). Once a user selects an answer and/or submits the answer, the answer card 222 can be displayed. As depicted, the user selected “anatomical structure,” which is incorrect. The correct answer was “nucleus.”

Accordingly, FIG. 2 depicts various implementations of questions that can be intelligently generated by implementations of the present invention. One will understand, however, that the depicted questions are merely exemplary and that questions of different types can be generated. Additionally, questions can be presented in formats different from those depicted.

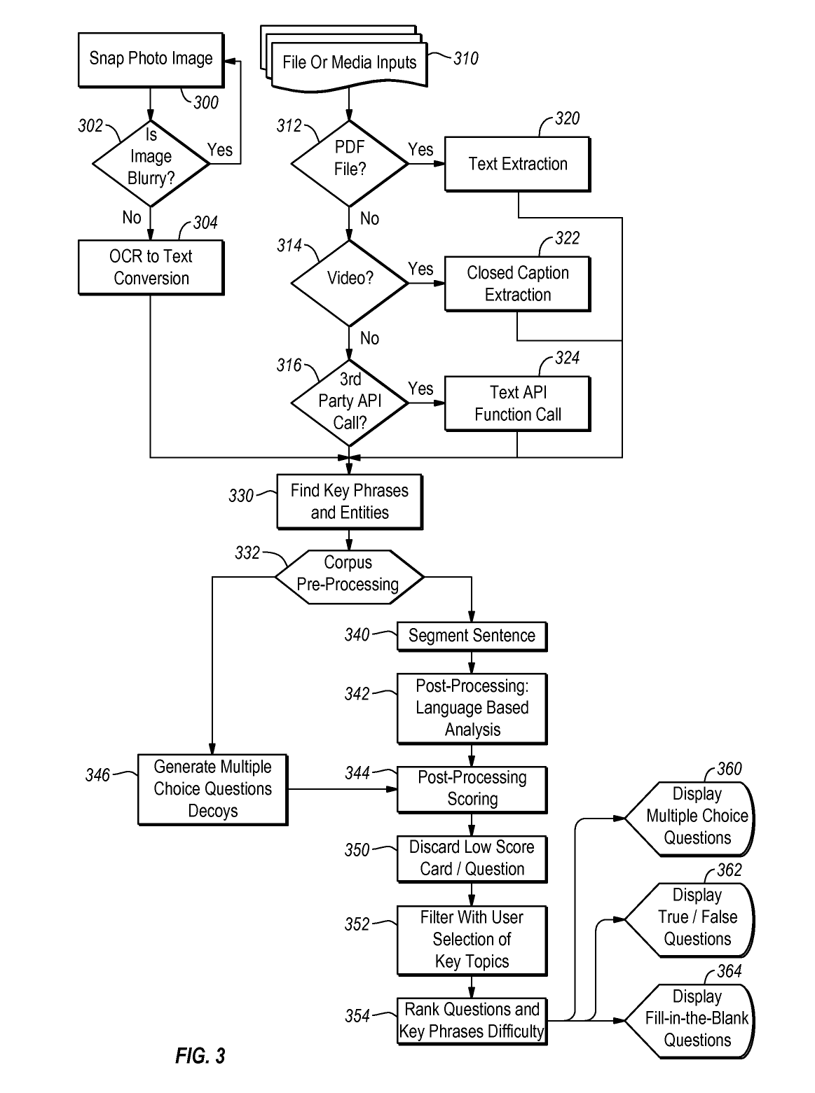

Turning now to FIG. 3, FIG. 3 illustrates a flowchart of steps within an implementation of a method for intelligently parsing digital content and generating questions based upon the digital content. As depicted, in at least one implementation, a photo image can be input into the system. Step 300 indicates a photo being captured. If the image is blurry 302 the image can be retaken. If the image is clear, however, the image can be processed through an OCR 304 to convert image content into text.

In addition to actively taking a photo, implementations of the present invention can also receive files of various media types 310. In various implementations, the type of file type received may impact how the content is processed. For example, if a PDF file is received 312, text can be extracted 320 from the PDF. The text extraction may comprise applying an OCR process to the PDF or direct extraction of text from the document itself. If the received file is a video file or video stream 314, implementations of the present invention can extract close captioning text 322 from the video. In alternative implementations, voice recognition processing can also be used to extract video content and turn it into text. If the received media file is unidentifiable, a third party API 316 can be utilized to convert the content into text 324. For example, a database search may be utilized to determine an API that is configured to receive the unknown format type. The database may also comprise the API function call 324 necessary to process the file.

Once the text has been extracted from the received content, the text can be processed to identify key phrases and entities 330. In at least one implementation, processing the text comprises sending the text through a third-party API (e.g., ALCHEMY API). In contrast, in at least one implementation, identifying key phrases and entities within the text 330 comprises comparing the text to a pre-defined key phrase and entity database. For example, the predefined key phrase and entity database may comprise historical figures, locations, scientific concepts, historical events, and other common academic topics. In such a case, key phrase and entities can be identified within the text content by identifying matching key phrases and entities within the predefined database.

Once key phrases and entities have been identified, the various text portions and key phrases can be processed in a corpus pre-processing step 332 that ranks the key phrases using statistical and occurrence analysis. In at least one implementation, the ranking can comprise rating each key phrase based on the total frequency with which it appears within the entire received text content, ranking each key phrase based upon the breadth of its dispersal throughout the entire text content, ranking each key phrase based upon its presence within titles and headers within the text content, and other similar ranking schemes.

For example, key phrases that are separated from the rest of the text may be given a higher ranking. For instance, key phrases that appear in bold lettering, are underlined, highlighted, or otherwise visually separated from the bulk of the text can be ranked higher. As an example, a user may upload her class notes into the Question Generator Engine 130. In addition to extracting text from the class notes using an OCR, the Question Generator Engine 130 can also analyze the image of the class notes to identify portions that were highlighted by the user. Highlighted key phrases can then be ranked higher than non-highlighted key phrases.

Once the key phrases have been ranked, decoy key phrases can be generated 346 and text portions can be segmented 340. In at least one implementation, segmenting the text portions can comprise breaking the text content into individual sentences and grammatically linked sentences. For example, two adjacent sentences may be grammatically linked if one of them utilizes a pronoun as a subject. In such a case, it may be necessary, to include one or more previous sentences to provide context to the pronoun. For example, the Question Generator Engine 130 may identify a sentence that states “He was the first President.” The Question Generator Engine 130 may further identify that the previous sentence states “George Washington was a Founding Father.” The Question Generator Engine 130 can identify the pronoun “He” in the latter sentence and determine it is necessary to combine with the previous sentence, which lacks ambiguity causing pronouns. As such, text portions can be automatically segmented into individual sentences or grammatically linked sentences.

Once the text has been segmented into different text portions, the text portions can be processed through a natural language processor 342 that can parse the text and extract useful information. To gather useful information, for example, natural language-based analysis can firstly be applied to these sentences to parse the grammatical structures and perform the lemma or stemming analysis. Employing such information can improve the quality of questions, i.e., 1) filtering out fragments (keeping only complete sentences), 2) filtering out vague meaning sentences such as those starting with pronoun, 3) identifying the positions, corresponding tenses and plural/singular of key phrases occurring in the sentences, and 4) keeping only meaningful key phrases whose grammatical structures are noun phrases.

As such, after language-based analysis, sentences and key phrases can be well scored and ranked. In at least one implementation, the scoring is based on the principle of “inverse-term-frequency”. Higher scores represent higher difficulty. Accordingly, key phrases with higher term frequency may have lower scores, and vice versa. The total score of each sentence can be obtained by the normalized average scores of all key phrases that occur in the sentence. The inverse-term-frequency principle conveys the idea of “frequently occurred key phrases are common or usual terms, representing the candidates of easier questions, and therefore having lower sentence scores”.

For example, the process can rank text portions based upon the number of key phrases within each respective text portion. Additionally, the process can gather various sentence structure and content data, such as identifying lists within sentences, identifying related key words within closely grouped text portions, and other similar data.

Once text portions and key phrases have been initially ranked, potential questions can be ranked in the post-processing scoring process 344. For example, the top ten rated key phrases may be identified as question topics. The top rated text portions that comprise one or more respective top ranked key phrases may then be identified for use as question outlines. Additionally, during the post-processing scoring process 344, various decoy key phrases can be paired with various potential questions.

After scoring the various questions, decoys, and key phrases, low-scoring questions can be discarded 350. Low scoring question may comprise those questions that focus on a low ranking key phrase or that are based upon text portions that ranked poorly. Additional questions may be filtered by user input 352. For example, a user can also be provided with an interface for filtering the questions to focus on or avoid select topics and key phrases.

Once the desired questions are determined, the questions can be arranged by difficulty 352 and displayed to the user 360, 362, 364. The questions can be divided between multiple-choice questions 360, true false questions 362, fill-in-the-blank questions 364, or may be focused on a subset of those question types. As the user answers question, the Question Generation Engine 130 can track key phrases that the user scores well with and those that the user struggles with. The Question Generation Engine 130 can adjust the presented questions based upon the user's performance.

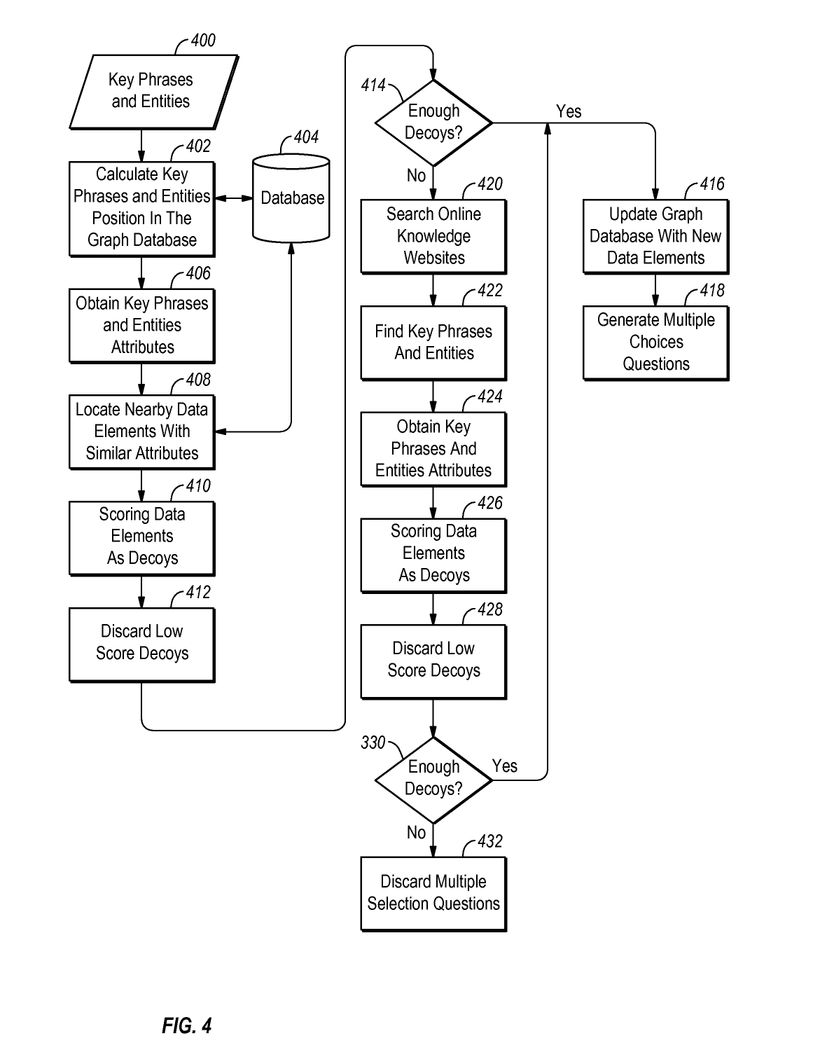

As recited above, in some implementations, generating a question also involves generating one or more decoy key phrases 346 (i.e., decoy answers). FIG. 4 illustrates a flowchart of steps within an implementation of a method for intelligently generating decoy answers. In particular, FIG. 4 depicts key phrases and entities being processed 400 through various steps in a method for generating decoy answers. Once key phrases are entered into the process, the process can calculate the positions of key phrases in a graph database 402. For example, the decoy database 148 of FIG. 1 may comprise a graph database. The graph database 148 can provide useful relational information between a key phrase and various potential decoys. For instance, a key phrase may comprise the name “George Washington.” The graph database may comprise an entry for the name “George Washington” that is linked to variety of different other people and to variety of different facts.

The graph database may also provide attributes for key phrases and potential decoys 406. For example, the graph database may provide geographic locations associated with particular key phrases, ages of people, key phrase types (e.g., person, place, theme, events, etc.), time frames associated with particular key phrases, and other similar key phrase specific facts. Using the keyword attributes provided by the graph database, decoy answers can be located based upon similar attributes between the potential decoy answers and the correct answer (i.e., the key phrase) 408. In at least one implementation, potential decoy answers can be identified based upon the distance between the respective potential decoy answers and the key phrase within the graph database.

For example, the key phrase “George Washington” may be associated with a type attribute of “person,” an attribute of “Founding Father,” and an attribute of a specific era of time. Using relational information from the graph database and the previously recited attributes, various decoys can be identified, such as Thomas Jefferson, John Adams, Benedict Arnold, and other similar individuals. Each of the identified potential decoy answers comprise at least a portion of the same attributes as the George Washington key phrase. For instance, each of the potential decoy key phrases are associated with a type attribute of person. Additionally, each of the proposed decoy key phrases is associated with a person alive during the same era as George Washington. Accordingly, one will understand that the above-described method can be applied to a wide variety of different circumstances.

Once various potential decoy answers have been identified, they can be scored 410 based on their respective similarity to the original key phrase. In at least one implementation, the score can be based upon the distance between the respective decoy answer data nodes within the graph database and the key phrase data node. The shorter the distance, the higher the rank for the decoy answer. Accordingly, a large number of potential decoy answers can be filtered and sorted based upon ranking. In at least one implementation, decoys that score below a certain threshold can be discarded 412.

After discarding the low ranking decoys, the process can comprise a step 414 for determining if there are enough proposed decoy answers. For example, it may be desirable in a multiple-choice question to have four total potential answers including the correct answer. As such, it may be desirable to have three potential decoy answers that rank higher than the threshold amount. In the case that sufficient decoy key phrases are available, the graph database can be updated with any new data elements derived from the text content 416 and the multiple choice questions can be generated 418.

In contrast, however, if there is an insufficient number of decoy answers, unstructured data, such as the Internet or the original user submitted content, can be searched for potential decoy key phrases 420. In at least one implementation, the unstructured data, as depicted by database 150 in FIG. 1, can comprise structured portions. However, the entirety of the data may not be structured. For example, various third-party online Encyclopedia databases may comprise structured information. However, these databases may also be searched concurrently with various blogs, journal articles, news sites, and webpages—creating an information source that as a whole is not uniformly structured.

When searching the unstructured data, the process can comprise searching for the key phrase 422. For example, the process may comprise searching the Internet for the key phrase “Abraham Lincoln.” Resulting data sources can be scored using natural language processing. In at least one implementation, the other sources can be scored by the frequency with which the key phrase of interest appears within the article. Additionally, in at least one implementation, the resulting data sources can also be scored based upon the number of occurrences of the key phrase, the density of appearances of the key phrase, and other similar metrics as applied to the respective data sources.

Once the data sources that contain the key phrase are identified, the respective text content can be processed with natural language processing to identify additional key phrases within the various data sources 424. The resulting discovered key phrases can be scored as potential decoy answers 426 based upon the number of times they appear in each respective data source, the commonality of each potential decoy answer among the different data sources, and other similar metrics. The resulting commonality indicator can be used to determine sort and rank the potential decoy answers.

The potential decoy answers that are identified and rated, can be filtered such that potential decoy answers that fall below a threshold ranking are discarded 428. At this point, the process can again determine if sufficient decoy answers exist 430 to provide the desired number of potential answers. If a sufficient number exist, the process can move forward with displaying the questions as recited above. In contrast, if an insufficient number of decoy key phrases were generated, the process can discard the associated multiple-choice questions 432 and move onto alternative key phrases to generate questions.

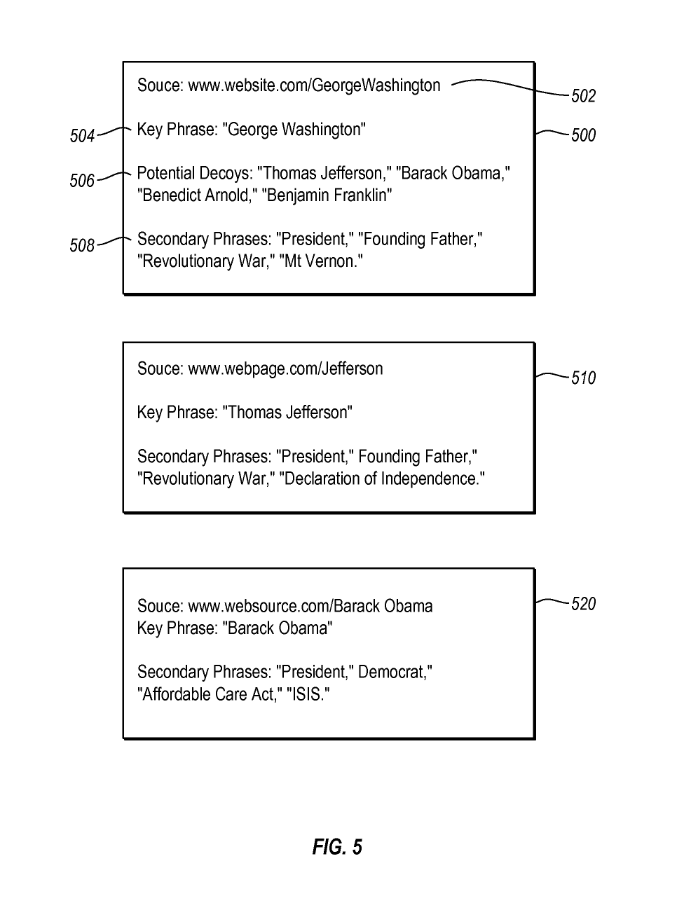

As recited above, in various implementations of the present invention, decoy answers can be generated using unstructured data. FIG. 5 illustrates implementation of data objects gathered from unstructured data that can be used to identify decoy answers. In particular, FIG. 5 depicts three data objects 500, 510, 520 that were gathered from unstructured data. A person of skill in the art will understand that the form and structure of the depicted data objects 500, 510, 520 is merely for the sake of clarity and is not meant to limit how data objects might otherwise appear.

Data object 500 comprises unstructured data that was returned for the key phrase “George Washington” 504. In at least one implementation, the unstructured data can comprise an indication of where the data was retrieved 502, potential decoys 506 that were identified within the same data source, and secondary phrases 508 that were identified within the data source.

The potential decoys 506 may be identified by processing the data source 502 through natural language processing and by cross referencing identified key phrases within the source 502 with the graph database. For example, potential decoys of “Thomas Jefferson,” “Barack Obama,” “Benedict Arnold,” and “Benjamin Franklin” were identified. These decoys may have been selected because the natural language processing identified each of these as names.

Data object 500 also comprises secondary key phrases 508 that comprise various other key phrases that were identified within the data source 502. In at least one implementation, the secondary key phrases 508 may comprise key phrases that were not selected as potential decoys. Additionally, in at least one implementation, the secondary key phrases 508 may be ranked based upon preference. For example, secondary key phrases 508 that appear within the graph database may be ranked higher than those that do not. In the depicted data object 500, the secondary phrases comprise “President,” “Found Father,” “Revolutionary War,” and “Mt. Vernon.”

In contrast to data object 500, which is directed towards the original key phrase 504, data object 510 and data object 520 are directed towards the potential decoys 506 of data object 500. In particular, each data object 510, 520 comprises information found through a search of the unstructured data and/or the decoy database for each respective potential decoy answer 506. For example, data object 510 is directed towards key phrase “Thomas Jefferson” and data object 520 is directed towards key phrase “Barack Obama.” As such, data object 510 represents data returned from a search for key phrase “Thomas Jefferson.” Similarly, data object 520 represents data returned from a search for key phrase “Barack Obama.” Each decoy data object 510, 520 also comprises various secondary phrases that are associated with the respective potential decoy answers 506. For example, the data object 510 for “Thomas Jefferson” is associated with “President,” “Founding Father,” “Revolutionary War,” and “Declaration of Independence.” In contrast, the data object 520 for “Barack Obama” is associated with “President,” “Democrat,” “Affordable Care Act,” and “ISIS.”

When selecting and ranking decoy answers, implementations of the present invention can identify a commonality rank between the potential decoy answers the key phrase 500 by comparing respective lists of secondary phrases. For example, “Thomas Jefferson” has several secondary phrases in common “George Washington.” As such, “Thomas Jefferson” would rank high in commonality with “George Washington,” and would rank high as a potential decoy answer. In contrast, “Barack Obama” has a few secondary phrases in common with “George Washington,” but not enough to receive a high commonality ranking. As such, “Barack Obama” would receive a low ranking as a potential decoy answer. Accordingly, implementations of the present invention can identify potential decoy answers within unstructured data by intelligently cross-referencing keywords within respective source content.

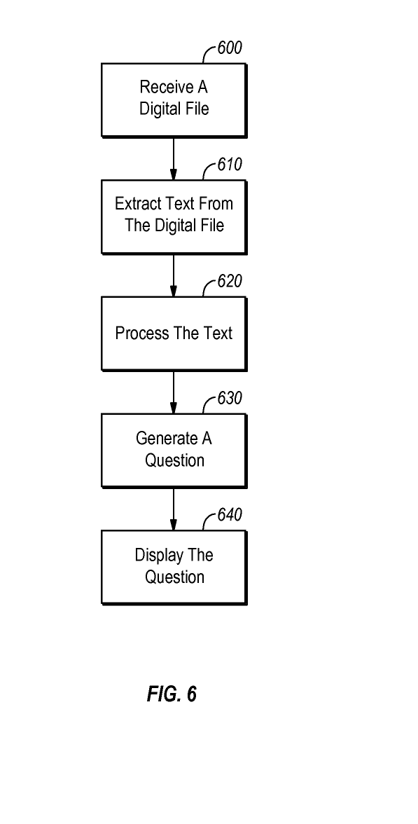

FIGS. 1-5 depict various implementations of the present invention that are adapted to intelligently generate questions. In particular, the present invention can automatically generate intelligent questions from nearly any common data source. One will appreciate that implementations of the present invention can also be described in terms of flowcharts comprising one or more acts for accomplishing a particular result. For example, FIG. 6 and the corresponding text describe acts in a method for generating questions. The acts of FIG. 1 are described below with reference to the elements shown in FIGS. 1-5.

For example, FIG. 6 illustrates that a method for intelligently parsing digital content and generating questions based upon the digital content can comprise an act 600 of receiving a digital file 600. Act 600 can comprise receiving a digitally encoded file, wherein the digitally encoded file comprises a known information media type. As used herein a digitally encoded file comprises any known digital media type or portions thereof, including, but not limited to, data packets, data objects, data sets, URLs associated with data content, and any other digital indicator that is directly or indirectly associated with information content. For example, as depicted and described with respect to FIG. 1, implementations of the present invention can receive video files 110, audio files 112, image files 114, scans of handwritten notes 116, and digital content files.

Additionally, FIG. 6 shows that the method can include an act 610 of extracting text from the digital file. Act 610 can comprise extracting text content from the digitally encoded file. For example, as depicted and described with respect to FIG. 1, a content processing module 140 can OCR image files, perform speech recognition on audio and video files, extract closed caption text from a video file, extract text from a digital document, and otherwise extract text from the various possible input sources.

FIG. 6 also shows that the method can include an act 620 of processing text. Act 620 can comprise processing the text content through an intelligent text analysis process. The intelligent text analysis process can identify key phrases within the digital content. For example, as depicted and described with respect to FIG. 1, a text analysis module 142 can perform natural language processing on the extracted text. The natural language processing can comprise using a third-party API, cross-referencing the text against a database, or otherwise identifying key phrases in the extracted text.

Further, FIG. 6 shows the method can include an act 630 of generating a question 630. Act 630 can comprise generating a question based upon a particular key phrase by manipulating a portion of the extracted text content. For example, as depicted and described with respect to FIG. 2, text portions from the original content can be used as a basis for generated questions. For instance, in the case of a multiple choice question, a key phrase can be removed from the text portion. A set of decoy answers, along with the removed key phrase, can be use as potential answers.

Further still, FIG. 6 shows that the method can include an act 640 of displaying the question. Act 640 can comprise displaying, on a display device, the generated question. For example, as depicted and described with respect to FIGS. 1 and 2, after a question is generated, the Question Generation Engine 130 can transmit the question 124 back to the client computer 100 for display. In at least one implementation, the act of transmitting the question for display is equivalent to the act of displaying the question.

Accordingly, implementations of the present invention provide significant improvements to the field of computer-curated questions. Additionally, implementations of the present invention provide significant improvements to the field of intelligent decoy answer generation. As such, a user can easily, and in real-time, enter a data source in the question generation engine 130 and have resulting questions automatically presented.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for intelligently parsing digital content and generating questions based upon the digital content comprising:
one or more processors; and
one or more computer readable media having stored thereon executable instructions that when executed by the one or more processors configure the computer system to perform at least the following:
receive a digitally encoded file, wherein the digitally encoded file comprises a known information media type;
extract text content from the digitally encoded file;
process the text content through an intelligent text analysis process, wherein the intelligent text analysis process identifies key phrases within the digital content;
generate a question based upon a particular key phrase by manipulating a portion of the extracted text content; and
display, on a display device, the generated question.

2. The computer system as recited in claim 1, wherein receiving a digitally encoded file comprises:
receiving a video file;
accessing the closed captions within the video file; and
parse the text within the closed captions.

3. The computer system as recited in claim 2, wherein the video file comprises receiving a video file stream.

4. The computer system as recited in claim 2, the computer-readable media comprising computer-executable instructions that when executed by the one or more processors further configure the computer system to perform at least the following:
receive an indication that a user has stopped or paused the video file; and
upon receiving the indication, display the generated question.

5. The computer system as recited in claim 1, the computer-readable media comprising computer-executable instructions that when executed by the one or more processors further configure the computer system to perform at least the following:
calculate the frequency that key phrases appear within one or more portions of the digital content;
calculate ranks for the one or more portions of the digital content, wherein the ranks are determined by the number of key phrases within each respective portion;
identify a particular portion of the one or more portions based upon the rank of the particular portion;
identify a particular key phrase within the particular portion; and
generate the question based upon the key phrase and the particular portion.

6. The computer system as recited in claim 1, wherein generating a question comprises:
searching for the particular key phrase within a decoy graph database;
identifying one or more decoy key phrases that are related to the particular key phrase;
determining a commonality indicator for each of the decoy key phrases compared to the particular key phrase;
selecting a set of the decoy key phrases with the highest respective commonality indicators; and
displaying, on the display device, the set of decoy key phrases as potential answers to the generated question.

7. The computer system as recited in claim 1, wherein generating a question comprises:
searching for the particular key phrase within a decoy graph database;
determining that the particular key phrase is not present within the decoy graph database;
searching unstructured digital data for the particular key phrase;
identifying one or more particular sources within the unstructured digital data that comprise the particular key phrase;
identifying, within the one or more particular sources, potential decoy key phrases;
calculate ranks for the potential decoy key phrases; and
displaying, on the display device, a set of the potential decoy key phrases based upon high ranks.

8. The computer system as recited in claim 7, wherein calculating ranks for the potential decoy key phrases comprises:
searching the unstructured digital data for a potential decoy key phrase;
identifying one or more decoy sources within the unstructured digital data that describe the potential decoy key phrase;
identifying, within the one or more decoy sources, secondary key phrases; and
calculate a rank for the potential decoy key phrase based upon the number of secondary key phrases that are common between the one or more decoy sources and the one or more particular sources.

9. The computer system as recited in claim 1, wherein receiving a digitally encoded file comprises:
receiving an image file; and
processing the image file through an optical character recognition process.

10. At a computer system including one or more processors and system memory, a method for intelligently parsing digital content and generating questions based upon the digital content, the comprising:
receiving a digitally encoded file, wherein the digitally encoded file comprises a known information media type;
extracting text content from the digitally encoded file;
processing the text content through an intelligent text analysis process, wherein the intelligent text analysis process identifies key phrases within the digital content;
generating a question and one or more answers based upon a particular key phrase; and
displaying, on a display device, the generated question.

11. The method as recited in claim 10, further comprising:
storing the particular key phrase to a previous-question database;
receiving an indication to generate a second question based upon the text content from received digitally encoded file;
identifying a next-question key phrase within the text content;
verifying that the next-question key phrase is not present within the previous-question database; and
generating a second question based upon the next-question key phrase.

12. The method as recited in claim 10, wherein generating the question and the one or more answers comprises:
identifying a portion of the text content that comprises the particular key phrase; and
generating the question by manipulating the portion of the text content.

13. The method as recited in claim 12, wherein generating the question and the one or more answers further comprises:
substituting the particular key phrase within the portion of the text content with a decoy key phrase selected from a decoy generator; and
generating a true or false question with the substituted decoy key phrase.

14. The method as recited in claim 12, wherein generating the question and the one or more answers further comprises:
removing the particular key phrase within the portion of the text content;
selecting a set of decoy phrases from a decoy generator; and
generating a multiple choice question that comprises as possible answers the set of decoy phrases and the particular key phrase.

15. The method as recited in claim 12, wherein generating the question and the one or more answers further comprises:
removing the particular key phrase within the portion of the text content; and
generating a fill-in-the-blank question, wherein the particular key phrase is stored for verification against a user-submitted answer.

16. The method as recited in claim 10, further comprising:
calculating the frequency that key phrases appear within one or more portions of the digital content;
calculating ranks for the one or more portions of the digital content, wherein the ranks are determined by the number of key phrases within each respective portion;
identifying a particular portion of the one or more portions based upon the rank of the particular portion;
identifying a particular key phrase within the particular portion; and
generating the question based upon the key phrase and the particular portion.

17. The method as recited in claim 10, wherein generating the question and the one or more answers comprises:
searching for the particular key phrase within a decoy generator;
identifying one or more decoy key phrases that are related to the particular key phrase;
determining a commonality indicator for each of the decoy key phrases compared to the particular key phrase;
selecting a set of the decoy key phrases with the highest respective commonality indicators; and
displaying, on the display device, the set of decoy key phrases as potential answers to the generated question.

18. The method as recited in claim 10, wherein generating the question and the one or more answers comprises:
searching for the particular key phrase within a decoy graph database;
determining that the particular key phrase is not present within the decoy graph database;
searching unstructured digital data for the particular key phrase;
identifying one or more particular sources within the unstructured digital data that comprise the particular key phrase;
identifying, within the one or more particular sources, potential decoy key phrases;
calculate ranks for the potential decoy key phrases; and
displaying, on the display device, a set of the potential decoy key phrases based upon high ranks.

19. The method as recited in claim 18, wherein calculating ranks for the potential decoy key phrases comprises:
searching the unstructured digital data for a potential decoy key phrase;
identifying one or more decoy sources within the unstructured digital data that describe the potential decoy key phrase;
identifying, within the one or more decoy sources, secondary key phrases; and
calculate a rank for the potential decoy key phrase based upon the number of secondary key phrases that are common between the one or more decoy sources and the one or more particular sources.

20. A computer system for intelligently parsing digital content and generating questions based upon the digital content comprising:
one or more processors; and
one or more computer readable media having stored thereon executable instructions that when executed by the one or more processors configure the computer system to perform at least the following:
receive a digitally encoded file;
extract text content from the digitally encoded file;
process the text content through an intelligent text analysis process, wherein the intelligent text analysis process identifies key phrases within the digital content;
generate a set of decoy answers by processing a particular key phrase through a decoy generator;
generate a question based upon the particular key phrase by manipulating a portion of the extracted text content; and
display, on a display device, the generated question and the set of decoy answers.
